(19) United States
(12) Patent Application Publication
(10) Pub. No.: US 2009/0209239 A1
(43) Pub. Date: Aug. 20, 2009

(54) SELF-SERVICE APPLICATION PLATFORM FOR WIRELESS DEVICES

(75) Inventor: DOMINGO LOPEZ MONTESDEOCA, MADRID (ES)

Correspondence Address: FOLEY HOAG, LLP;PATENT GROUP, WORLD TRADE CENTER WEST, 155 SEAPORT BLVD, BOSTON, MA, 02110, US

(73) Assignee: MOVIDILO S.L., Madrid (ES)

(21) Appl. No.: 12/032,742

(22) Filed: Feb. 18, 2008

(51) Int. Cl. H04Q 7/22; G10L 11/00

(52) U.S. Cl. 455/414.2; 704/270.1

(57) ABSTRACT

A method and system are provided for enabling users of mobile devices to remotely perform self-service tasks involving a given entity without using human intermediaries. The system includes a server computer running a self-service application for the given entity; and a plurality of mobile devices, each operated by a user for communicating with the server computer over a wireless communications network. Each of the mobile devices including a non-browser based, goal-oriented, self-service application running on a self-service client with a graphical user interface adapted for allowing a user of the mobile device to remotely interact with the self-service application running on the server computer to automatically manage tasks involving the given entity.

### BACKGROUND

The present application relates generally to mobile communications devices such as cellular phones and, more particularly, to a platform for executing self-service applications for such devices.

### BRIEF SUMMARY OF EMBODIMENTS OF THE INVENTION

In accordance with one or more embodiments of the invention, a system is provided for enabling users of mobile devices to remotely perform self-service tasks involving a given entity without using human intermediaries. The system includes a server computer running a self-service application for the given entity; and a plurality of mobile devices, each operated by a user for communicating with the server computer over a wireless communications network. Each of the mobile devices including a non-browser based, goal-oriented, self-service application running on a self-service client with a graphical user interface adapted for allowing a user of the mobile device to remotely interact with the self-service application running on the server computer to automatically manage tasks involving the given entity. In accordance with one or more embodiments of the invention, each of the mobile devices includes local applications that are accessible with the self-service application from the graphical user interface in an integrated operating environment.

In accordance with one or more embodiments of the invention, a method is provided for enabling users of mobile devices to remotely perform self-service tasks involving a given entity without using human intermediaries. The method includes: running a self-service application at a server computer for the given entity; and for each of the mobile devices, providing a self-service client and a non-browser based, goal-oriented self-service application. The self-service client and the self-service application provide a graphical user interface adapted for allowing a user of the mobile device to remotely interact over a wireless communications network with the self-service application running on the server computer to automatically manage tasks involving the given entity.

In accordance with one or more further embodiments of the invention, a method is provided for enabling a user of a mobile device making a telephone call to a call center or IVR to remotely perform self-service tasks involving a given entity without using human intermediaries. The method includes: receiving a telephone call from the mobile device of the user at a call center or IVR; informing the user of the availability of a self-service application to perform a desired task; activating a self-service application on the mobile device; and enabling the user to perform the desired task without using human intermediaries using the self-service application.

In accordance with one or more further embodiments of the invention, a method is provided for enabling a user of a mobile device to remotely perform self-service tasks involving a given entity without using human intermediaries. The mobile device is configured to allow the user to access local content and applications and mobile self-service applications stored on the mobile device from a single integrated interface on the mobile device. The method includes: (a) sending a notification to the mobile device of the availability a product or service from the given entity accessible by the user from the mobile device; (b) activating a self-service application on the mobile device to access the product or service; and (c) enabling the user to perform a desired task relating to the product or service without using human intermediaries using the self-service application.

Various embodiments of the invention are provided in the following detailed description. As will be realized, the invention is capable of other and different embodiments, and its several details may be capable of modifications in various respects, all without departing from the invention. Accordingly, the drawings and description are to be regarded as illustrative in nature and not in a restrictive or limiting sense, with the scope of the application being indicated in the claims.

### BRIEF DESCRIPTION OF THE DRAWINGS

FIGS. 1A to 1E are screenshots illustrating operation of an exemplary self-service application in accordance with one or more embodiments of the invention.

FIGS. 2A to 2G are screenshots illustrating operation of another exemplary self-service application in accordance with one or more embodiments of the invention.

FIG. 3 is a block diagram of a self-service system in accordance with one or more embodiments of the invention.

FIG. 4 is a block diagram of an exemplary mobile device in accordance with one or more embodiments of the invention.

FIG. 5 is a block diagram illustrating operation of the self-service client and self-service applications on a mobile device in accordance with one or more embodiments of the invention.

FIG. 6 is a block diagram a self-service system illustrating an adaptive thin/thick client feature in accordance with one or more embodiments of the invention.

FIG. 7 is a flow chart illustrating an exemplary process for remotely activating a self-service application on a mobile device to complete a desired task in accordance with one or more further embodiments of the invention.

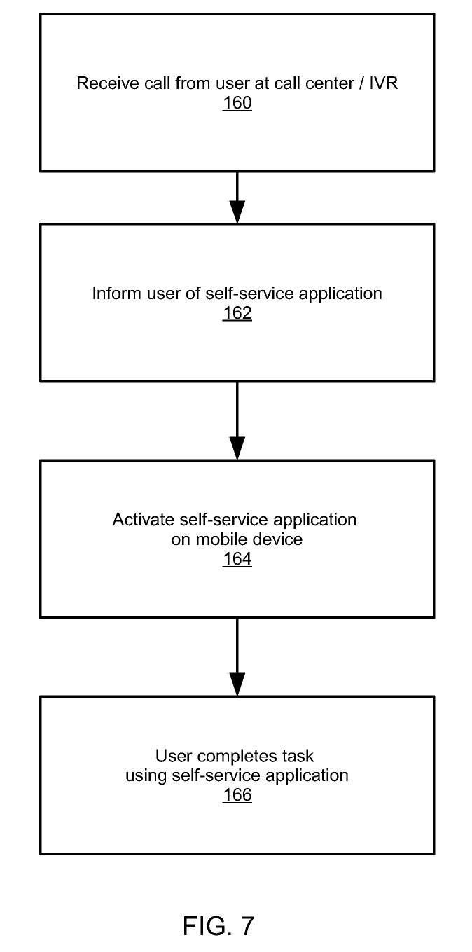

FIG. 8 is a flow chart illustrating an exemplary process for enabling a user of a mobile device to remotely perform self-service tasks, the mobile device being configured to allow the user to access local content and applications and mobile self-service applications from a single integrated interface in accordance with one or more further embodiments of the invention.

### DETAILED DESCRIPTION

Many enterprises and other entities, particularly medium and large size businesses, use customer relationship management (CRM) systems to manage their relations with customers. These systems seek to automate the capture, storage, and processing of information from customer interactions. They, however, often require customer/sales representatives or call center agents to interact with customers and feed the customer database. Use of self-service applications can improve the automation of many of these tasks. A self-service application is an application that allows customers and other users to access information and perform tasks (e.g., download content, perform transactions such as buy a product, review a bill, and configure a service) remotely, typically over networks such as the Internet, without requiring interaction with human intermediaries or interactive voice response systems (IVRs). Self-service applications are goal-oriented instead of navigation-oriented in that users have an objective when they interact with the self-service applications, i.e., the users want to accomplish a particular task unlike typical web-browsing, which is navigation-oriented.

One or more embodiments of the present application are directed to a mobile self-service platform addressed to developing and executing complex goal-oriented self-service applications. The self-service applications are available from a platform designed specifically to run mobile self-service applications using mobile devices through wireless networks. The self-service applications enable users of mobile devices to manage personal tasks without human intermediaries. Users can effectively use the self-service applications at anytime, anywhere using a mobile handset and a wireless data connection. This functionality increases performance, eliminating long and expensive telephone calls with human intermediaries, and providing significant benefits to customers of improved satisfaction and to enterprises of lower costs.

In some embodiments, the self-service applications are used to obtain customer care as will be described in further detail below. In some embodiments, the self-service applications are integrated with local applications and content on the user's mobile device and accessible from a single user interface to provide a homogenous operating environment.

The self-service client and applications in accordance with various embodiments provide a user interface that is dynamic, easy to use, and goal oriented. They are particularly designed to fit mobile handset limitations, thereby avoiding data overloads and usage interruptions.

The self-service applications in accordance with various embodiments of the invention are preferably not browser-based. Web micro-browsers, which are compact versions of personal computer (PC) browsers tailored to mobile devices, were generally designed to surf the Web. Executing complex applications using micro-browsers is difficult on mobile devices due to the limitations of mobile devices including small screen size and limited user input mechanisms. Dedicated applications could be used, but these would require multiple installations on mobile devices, which are typically limited in the number of applications that could be installed together.

Self-service applications in accordance with various embodiments of the invention can be used for a variety of purposes. For instance when used in obtaining customer care, self-service applications can be used for a number of purposes including, but not limited to, conducting transactions, accessing information, accessing mobile location services, responding to promotional offers, conducting searches, collecting data, managing consumption control, managing loyalty points, managing product or service administration and configuration, invoicing, managing a price plan wizards to help users select an optimal price plan from mobile operators, managing Telco products (including configuring voicemail, message system, etc.), locating a business near a given location, managing appointments, managing and tracking orders, managing promotions and campaigns, managing banking services and brokerage, obtaining transport information and logistics, and participating in elections and surveys.

In accordance with various embodiment of the invention, a virtually infinite number of mobile self-service applications can be accessed by user mobile devices, thereby avoiding the tedious process of installing an application in the mobile device each time new applications are required. This also eases the task of administering installed application to handle the limited memory resources usually available in mobile devices.

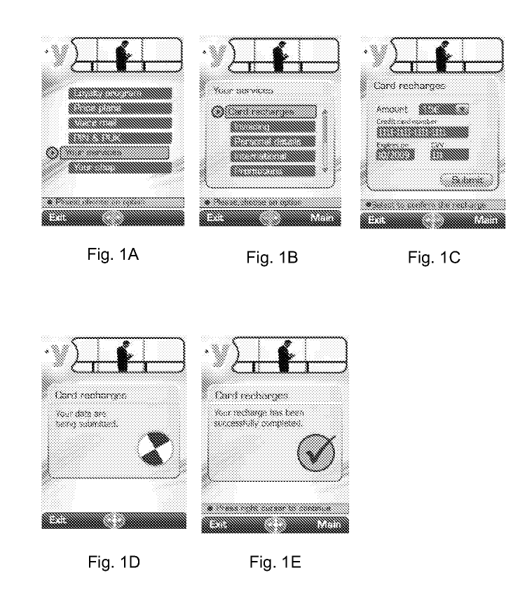

FIGS. 1A-E are exemplary screenshots of a display on a user device illustrating operation of an exemplary self-service application for obtaining customer care in accordance with one or more embodiments of the invention. In this example, a user is using the self-service application to recharge a pre-paid charge card. In FIG. 1A, the user is presented with a main menu listing various self-service options. In this example, the user selects the “Your Services” option, and is presented with a further menu shown in FIG. 1B. In this menu, the user selects the “Card Recharges” option, and is presented with a screen shown in FIG. 1C, which allows the user to enter billing information. The mobile self-service client on the mobile device transmits the data as indicated in the screen of FIG. 1D (to a server system and a customer care business process system). Once the server system and the customer care business process system successfully process the transaction, the user is notified as shown in FIG. 1E.

In some embodiments, the self-service applications are used in a mobile user portal in which local applications and content and the self-service applications are accessible from a single user interface. The mobile user portal can be used for various purposes including, but not limited to, ticketing (buying cinema, theater, show, flight or other travel tickets), downloading content (including music, video, and images), browsing content, organizing content, sharing content, accessing personalized news and information, conducting mobile navigation, mobile searching, mobile dating, and mobile marketing.

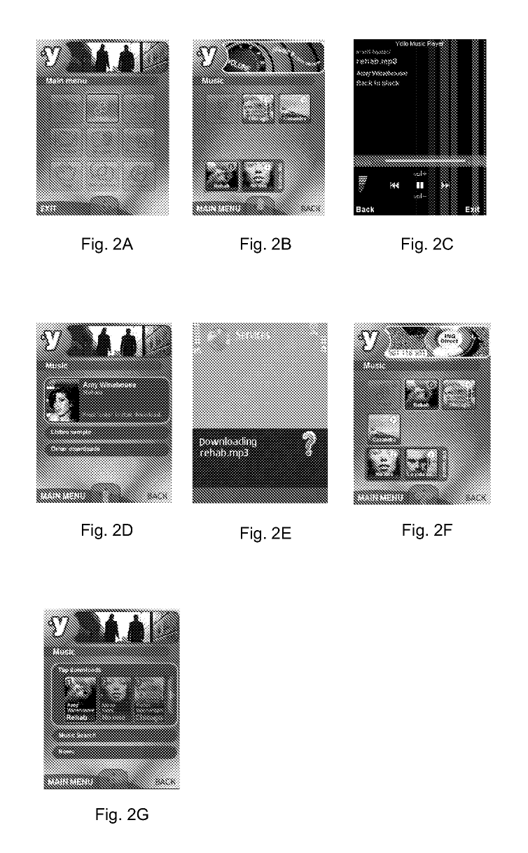

FIGS. 2A to 2G are screenshots illustrating operation of an exemplary self-service application used in a mobile user portal in accordance with one or more embodiments of the invention. This example illustrates use of a mobile portal self-service application for downloading and playing music. In the screenshot in FIG. 2A, the user is presented with a main menu with various self-service application options. The user selects the “music channel” option, and is presented with the screen of FIG. 2B. In the screen, the user can select a “play local content” option, in which case the screen of FIG. 2C is presented to the user. Here, the user can play local content already downloaded on the mobile device executing a mobile local player. The mobile self-service application thereby interacts with a local application. Alternately, the user can select a “download new content” option from the FIG. 2B screen. In this case, the user can download new content and receive personalized offers, e.g., based on a user profile and/or previous user behavior. As the selected content is downloaded from the remote server system, the user is presented with a screen of FIG. 2E. Once the content has been downloaded, it will appear on the music channel available as local content ready to be played, as shown in FIG. 2F. From the screen of FIG. 2B, the user can also access a service provider (e.g., Telco) portal, which can offer features to the user for self-service (e.g., access to top downloads, search content on servers, and access channel news) as shown in FIG. 2G.

Various other mobile user portal usages are also possible. For example, in downloading content and media (music, video, images, and games), users have the same mobile interface access to both local and remote content and media through, e.g., browsing and search operations. In some instances, content might be locally installed on the mobile device. In some instances, content might be remotely stored on a mobile service provider server from a previous content acquisition by the user. In some instances, the content might be available on a content provider server to buy and download with, e.g., a single click, which can be based on a personalized selection of a recently viewed item or a top download. The self-service application on the mobile device can execute a local application to provide, e.g., media playback, or operation of a game or other application. In addition to content access and application execution, self-service applications may provide access to Internet/mobile pages and search sites. The self-service application can act as a gate to the Internet site. The self-service application could help the user choose the site and provide data to access information on the site prior to being transferred to a mobile browser. For example, an Internet search site might be able to obtain better results if it already has particular information (such as, e.g., location information based on GPS) from the mobile device in order to restrict the search and achieve better results. In this way, local applications can operate with remote sites to improve the user experience.

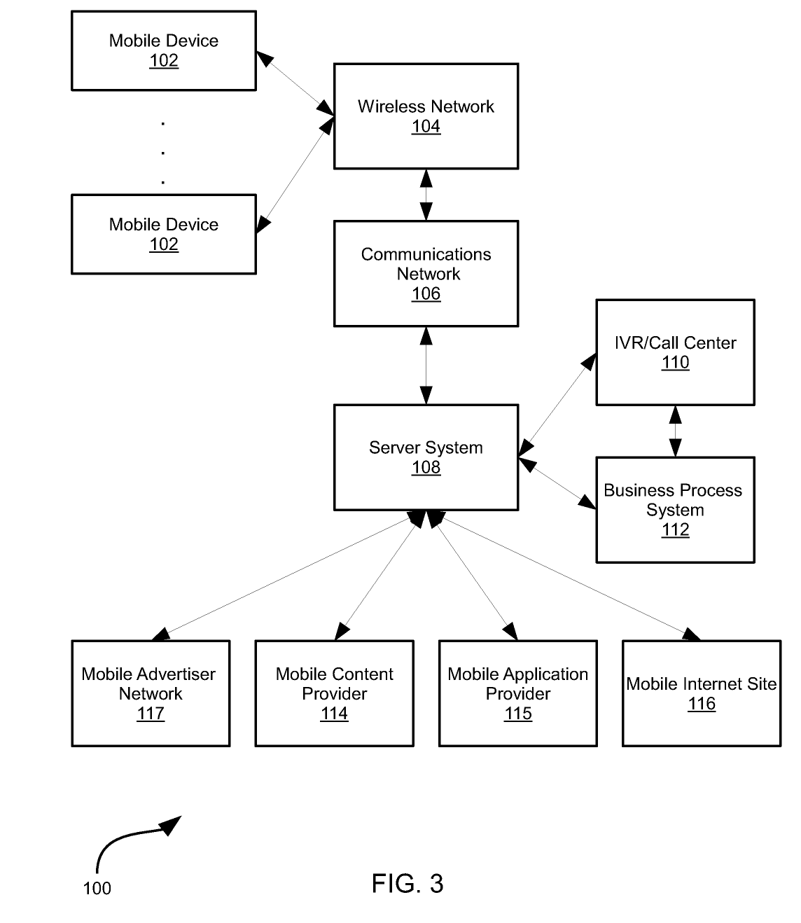

FIG. 3 is a block diagram of an exemplary system 100 in which embodiments of the invention can be implemented. The system 100 includes a plurality of mobile communications devices 102, a wireless data network 104, a communications network 106, and a server system 108. In certain embodiments, the system 100 also includes an IVR/call center system 110, which can interact with the server system 108 as described below. In certain embodiments, the system 100 also includes a business process system 112, which can interact with the server system 108 and the IVR/call center system 110. The business process system 112 can include, e.g., CRM systems, databases, content management systems, knowledge management systems, and e-commerce stores. In certain embodiments, the system 100 further includes mobile content providers 114, mobile application providers 115, mobile Internet sites 116, and a mobile advertiser network 117, each interacting with the server system 108.

The mobile devices 102 can include a variety of portable computing devices capable of connecting to another computing device and receiving information. The mobile device 102 transmits information to and receives information from the server system 108 via the wireless data network 104 and the communications network 106. Examples of mobile devices 102 include portable devices such as, e.g., cellular telephones, smartphones, Personal Digital Assistants (PDAs), handheld computers, laptop computers, and the like.

The wireless data network 104 is configured to couple mobile devices 102 with the communications network 106. The wireless data network 104 can include any of a variety of networks including cellular communications networks, mesh networks, Wireless LAN (WLAN) networks, and the like. The wireless data network can further employ a plurality of access technologies including 2nd (2G), 3rd (3G) generation radio access for cellular systems, WLAN, Wireless Router (WR) mesh, and the like. Access technologies such as 2G, 3G, and future access networks can provide wide area coverage for mobile devices 102. For example, wireless data networks 104 can provide a radio connection through a radio network access such as Universal Mobile Telecommunications System (UMTS), Global System for Mobile communication (GSM), General Packet Radio Services (GPRS), Enhanced Data GSM Environment (EDGE), Wideband Code Division Multiple Access (WCDMA), and the like. In short, the wireless data network 104 can include virtually any wireless communication mechanism by which information may travel between mobile device 102 and another computing device, network, and the like.

The communications network 106 is configured to couple the server system 108 with other computing devices, including mobile devices 102, through the wireless network 104. The communications network 106 can be, e.g., the Internet, an intranet, or other network connection.

The IVR/call center system 110 and the business process system 112 can provide various customer care services to users. The mobile content provider 114, mobile application provider 115, mobile Internet sites 116, and mobile advertiser network 117 interact with the server system 108 to provide a user mobile portal, from which users can, e.g., download music and other content and media, play games, interact with others in social networking sites, and browse the Internet.

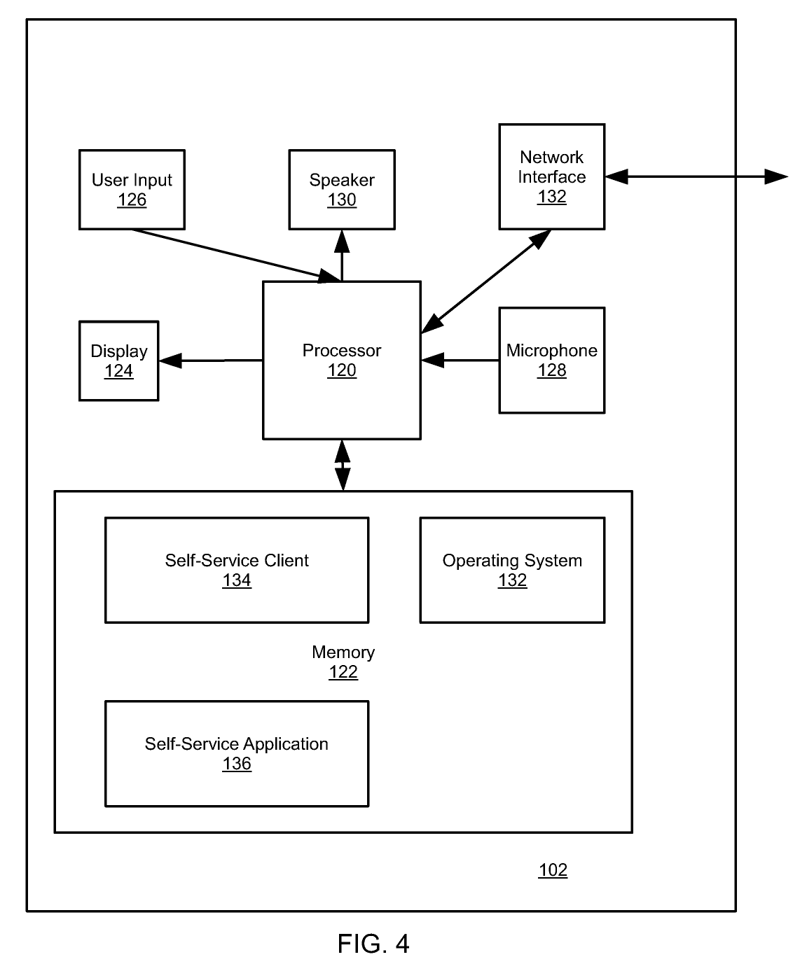

FIG. 4 is a block diagram of an exemplary mobile device 102 in accordance with various embodiments of the invention. The mobile device 102 includes, among other components, a processor 120, a memory 122, a display 124, a user input device 126 (e.g., a keypad and/or touch sensitive screen), a microphone 128, a speaker 130, and a network interface 132.

The processor 120 is operative to exercise overall control and to process data for transmission or reception. The network interface 132 is coupled to the processor 120 and operative under the control of processor 120 to perform those functions required for establishing and maintaining a two-way wireless communication link with the wireless data network 104. In general use, the processor 120 is also operative to execute other applications such as applications serving to download audio and/or video data to be reproduced by mobile device 102, e-mail clients and applications enabling the user to play games using the mobile device 102. As will be described in further detail below, in accordance with various embodiments, the processor 120 is also operative to execute one or more self-service applications.

Memory 122 generally includes both volatile memory (e.g., RAM) and non-volatile memory (e.g., ROM, Flash Memory, or the like). The mobile device 102 includes an operating system 132 resident in memory 122 and configured to execute on processor 120 for use in controlling operation of mobile device 102.

A mobile self-service client 134 and one or more self-service applications 136 are also stored in memory 122. The self-service client 134 allows a user of the mobile device 102 to interact with remote self-service applications stored on the server system 108 across the wireless network 104 and the communications network 106. The self-service client 134 is responsible (in different degrees) for the graphical user interface and the communication between the user and self-service applications residing on the server 108. The mobile self-service client 134 and self-service applications 136 can be installed on the mobile device 102 during manufacturing of the device or at a later time, e.g., over the air.

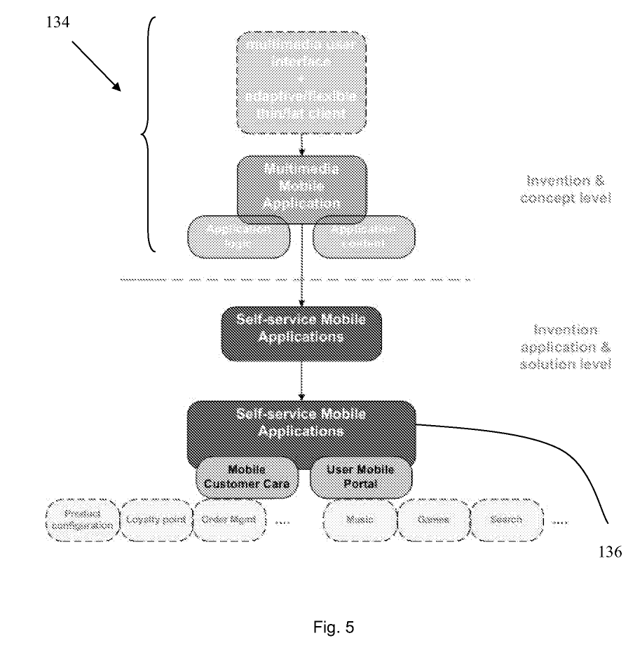

FIG. 5 illustrates, in further detail, operation of the self-service client 134 and self-service applications 136. As shown, self-service applications 136 can be directed to various applications including mobile customer care applications and/or user mobile portal applications. The self-service client 134 includes a multimedia user interface (MUI) engine and an adaptive (i.e., flexible) thin/thick client adaptability feature, which will be described in further detail below.

The MUI engine controls the execution of the graphical user interface and can manage content in different formats (audio, images, video, animations, etc.). MUI components can include one or more of the following: (1) a goal-oriented wizard, which helps users to reach a desired goal by means of transiting from one application state to other; (2) a cursor key indicator, which indicates to users what cursor keys they can use depending on the application state; (3) interactive forms, which allow users to enter information in self-service applications; (4) forms, which can have different types of numeric or alphanumeric fields such as: name, surname, card number, account number, postal code, street, city, country, etc.; (5) custom predictive dictionaries, which can be used in given fields to suggest to users possible data based on their previous interactions; (6) an animation engine, which allows animations to be executed based in image sequences; (7) transition effects, which can be used in application state transitions p.e scroll, fade-in, fade-out, transparencies, etc.; (8) a pop-up window control, which can be useful to show important messages to the user like errors, warnings, etc.; (9) a volume control, which allows users to modify the audio volume level; (10) an inactivity control, which can be used to close the application session if the user does not interact with the application in a given period of time; (11) a configurable soft-key menu, which allows developers a flexible configuration of the soft-key menu; (12) telephony control, which allows self-service applications 136 to emit phone calls automatically; (13) a remote logging system, which can trace the activity of the self-service client 134 and sent it to the server 108 in order to detect possible defects; (14) a multimodal client, which can be part of a multimodal interface running in the client 134, and is generally responsible to capture the user voice and send it to the server 108 for speech recognizing; (15) a mobile update manager, which is part of the updating manager running in the client 134, and allows the client 134 to update itself (as described in further detail below); (16) a cache system with pre-fetching, which allows pre-loading application logic and content in the mobile device memory 122 during the application start-up and pre-fetching subsequent application states as the user interacts with the application; and (17) a device adaptation system, which allows the client 134 to adapt itself to the mobile device 102 and negotiate with the server 108 which content is more suitably processed by the client 134 or the server 108 as discussed in further detail below.

In accordance with one or more embodiments of the invention, an adaptive execution environment is provided, in which for each session or for mobile device 102, the self-service client 134 on a mobile device 102 is selectively adapted as a thin client or a thick client or a hybrid thin/thick client. As a thin client, the mobile device 102 relies primarily on the server system 108 for processing activities of self-service applications 136, including processing of application logic (i.e., states of application and workflow) and application content (i.e., rendering of graphical user interface (GUI) elements including text, images, and audio). As a thick client, the mobile device 102 primarily performs the processing activities of self-service applications 136, and communicates with the server system 108 to send and retrieve data as needed.

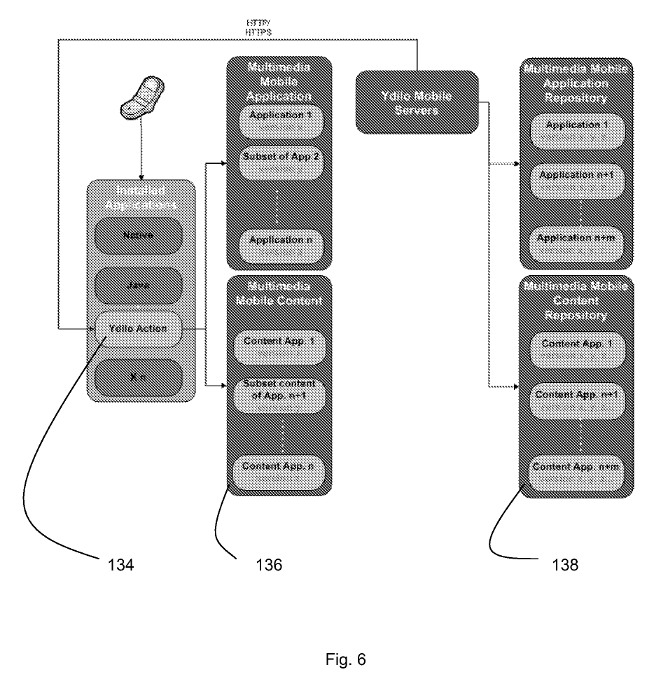

FIG. 6 illustrates, in further detail, the adaptive execution environment in accordance with one or more embodiments of the invention. As shown, the mobile device has installed thereon a self-service client application 134 (identified in this drawing as “Ydilo Action”), which operates self-service application logic and content 136. The server system 108 includes corresponding self-service applications and content 138.

The degree to which a self-service application is executed on the mobile device 102 and on the server system 108 can be varied for a number of reasons including, e.g., on the basis of characteristics of the mobile device or network limitations. For example, if the wireless network connection is poor, the self-service client 134 is preferably adapted as a thick client, particularly if the mobile device has good processing capabilities. On the other hand, if there is a good network connection, the self-service client 134 can be adapted as a thin client. The self-service client 134 preferably checks the mobile device characteristics and network limitations at application startup and adapts itself to the environment in order to provide the best level of usability.

Various client configurations are possible, including the following:

(1) Thick client: The self-service application 136 is generally completely available locally on the mobile device 102. No remote access is required to interact and use the application 136, aside from queries to retrieve information/content or transaction execution on the server side.
(2) Thin client: The self-service application 136 is generally completely available remotely on the server system 108. The application logic is controlled on server side and each state is downloaded locally on the mobile device 102 for reproduction and user interaction. Results are sent back to server 108 to evolve the application to a new state.
(3) Hybrid Thin/Thick Client: The self-service application 136 is partially available locally on the mobile device 102 and the reminder on server system 108 (i.e., most used application part versus dynamic states).
(4) Any combination of the above where local mobile device 102 and server system 108 work jointly to generate user experience state by state.

All these processes are preferably transparent from the user's perspective.

In accordance with one or more further embodiments of the invention, a method is provided for receiving a voice call from a user and subsequently transferring the user to a mobile self-service application 136 to automate the completion of a desired task. In particular, a customer service channel such as a call center or IVR 110 can capture incomings voice calls, and can use a messaging mechanism (such as multimedia messaging service (MMS) or short message service (SMS)) to wake-up a particular self-service application 136 on user mobile device 102, which the user can use to complete a task. FIG. 4 illustrates an exemplary use case workflow.

At step 160, the IVR system or call center 110 receives a telephone call from a user to perform a desired task. At step 162, the IVR or call center agent informs the user of the availability of a self-service application 136 that can be used by the user to perform the task, and invites the user to use the mobile self-service option. In some cases, the IVR or call center 110 may obtain some information from the user prior transferring to a mobile self-service application 136 to determine user requirements in order to select the appropriate mobile application 136 to be remotely started. In some cases, the transfer might be performed directly without requesting user acceptance. At step 164, the call center or IVR 110 activates the self-service application 136 (using, e.g., a messaging mechanism to wake up the application) on the mobile device, and the user interacts with the self-service application 136 to complete the desired task at step 166. In some cases, the call center operator or IVR may continue to interact with the user through the voice channel at the same time the user operates the self-service application to assist the user through navigation in a multimodal (voice and visual) interaction interface.

In accordance with one or more further embodiments of the invention, if a user of a self-service application 136 wishes to communicate through another customer service channel such as a call center or IVR 110, the user can transfer to the desired customer service channel, and data captured from a user through the self-service application 136 can be forwarded to the call center or IVR 110, in order to avoid having the user provide the information again. The self-service client 134 preferably automatically places the call to the call center or IVR 110.

Various self-service application initiation workflows are possible that allow a user to interact with a business process system through a mobile self-service application. For example, in some embodiments, the self-service client 134 provides a menu to the user, allowing the user to choose one of a plurality of available services. Each service in the menu can be implemented using different customer interaction channels (such as, e.g., IVR, mobile self-service application 136, Web, call center, etc.). Once the customer interaction channel has been selected, the self-service client 134 preferably automatically connects the user to that channel, e.g., a telephone call is dialed, a URL is invoked, or a self-service application 136 is executed.

In accordance with one or more further embodiments of the invention, a push notification mechanism is provided to trigger asynchronous events on the client 134 installed on the mobile device 102. The mechanism can be used to notify users about something of potential interest to the users. The mechanism can also be used to invite users to perform some action such as responding to a promotion, or checking new information or content.

The notification could be sent to the mobile device 102 in a message (e.g., SMS or MMS). Upon receiving the message, the self-service client 134 reads the message and preferably asks the user for approval to execute itself to assist the user by performing a specific action relating to the message. For example, if the message contains a marketing promotion, the user can be asked for permission to connect to a server to read it. In the event the user denies permission to the self-service client 134, the self-service client 134 can be configured to remind the user of the message at another time, e.g., to inform the user about an expiration time for a particular promotion. The self-service client 134 can also navigate to a particular self-service application state driven by message content (e.g., SMS with promotion of a new music news release could drive self-service client 134 to a music channel self-service application 136 where an album is available for sale or downloading).

In some embodiments, a local application being executed on the mobile device (e.g., a game) might invite the user to use a self-service application to continue interaction. In some situations, the local application can initiate the self-service application and terminate.

As indicated above, to provide a user mobile portal in accordance with various embodiments of the invention, self-service applications 136 are integrated with local applications on the mobile device 102 to provide a user with a personalized environment. Users normally access mobile self-service applications 136 (e.g., for accessing information, downloading content, performing transactions on business process system, etc.) as well as execute local functions (e.g., browsing, cataloguing, etc.) from the same mobile device 102. Combining self-service applications 136 and local applications allows operation in a homogeneous space through an integrated interface. For example: browsing, cataloguing, editing/compositing media tools can coexist with the same application environment as corporate self-service applications 136 (e.g., contact center, content portal, etc.).

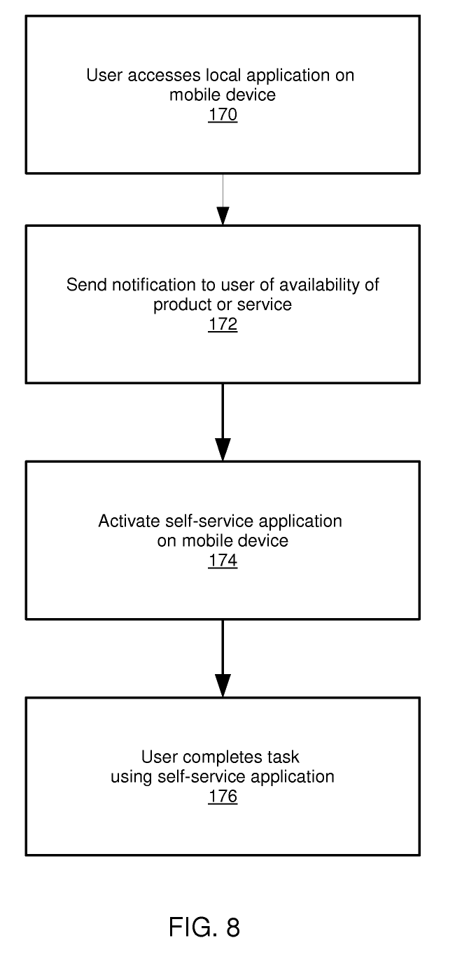

FIG. 8 illustrates an exemplary method by which a user of a mobile device 102 can remotely perform self-service tasks using a mobile device 102 having a single integrated interface allowing the user to access local content and applications and mobile self-service applications 136 stored on the mobile device 102. At step 170, the user operates the mobile device to, e.g., access local applications (such as a media player or a browser). At step 172, the server system 108 sends a notification to the mobile device 102 of the availability a product (e.g., new content) or service accessible by the user from the mobile device 102. This may occur, e.g., as a result of user activity such as browsing. At step 174, the server system 108 activates a self-service application 136 on the mobile device 102 to access the product or service. At step 176, the user performs a desired task relating to said product or service without using human intermediaries using the self-service application 136.

In accordance with one or more further embodiments of the invention, self-service application logic and content are runtime controlled using client stored profile and corporate rules. A desired user experience and content can be provided to the right user, depending of marketing rules and schemas. Various uses are possible. One exemplary usage is for consumption control relating to a Telco operator. The self-service application may retrieve information from the business process system to understand customer usage and thereby identify only suitable options to the user (e.g., not to offer prepaid options to a post paid user). In a music and content related application, the self-service application might track user behavior (e.g., the number of times a type of media content is played) to offer personalized particular new media expected to be of interest to the user. Another exemplary usage could relate to product or service administration and configuration. In this example, the self-service application can be configured to list options using a user personalized order instead of a general predefined sorting. The selection can streamline the access of customers to their preferred corporate services, which may be particularly useful in a mobile environment. Another possible exemplary usage relates to order management. The self-service application might combine local history information from previous sessions to change a main menu. For example, if the user has already placed an order to be delivered, the self-service application first checks with the server order status and informs the user each time the service is initiated, thereby anticipating an actual user intention when accessing the self-service application.

In accordance with one or more embodiments of the invention, the mobile update manager in the self-service client 134 updates client applications automatically when it detects changes in a given application, or if it receives notification from a remote logging system detecting a possible software failure in the client.

In accordance with certain embodiments, the available self-service applications 136 or application versions can change from one user session to the immediate next one. This is particularly useful when there is a massive deployment of mobile applications (e.g., in a Telco environment) and it can be critical for the business that all of them change versions at a predetermined synchronized time/day (e.g., to make available a new marketing promotion).

In accordance with certain embodiments, application information and user behavior can be stored locally for future use in new sessions (e.g., to provide user assistance on filling a form, to match a marketing promotion with user behavior to display a personalized message, etc.).

In accordance with certain embodiments, the various features described herein can be personalized in accordance with a user profile in order to provide a unique proposal for a particular user context in each moment. For example, two different users could be provided different combinations of applications versions, subset application state versions, and application content versions.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

The techniques described above may be implemented, e.g., in hardware, software, firmware, or any combination thereof.

Having described preferred embodiments of the present invention, it should be apparent that modifications can be made without departing from the spirit and scope of the invention.

What is claimed is:

1. A system for enabling users of mobile devices to remotely perform self-service tasks involving a given entity without using human intermediaries, the system comprising:
a server computer running a self-service application for the given entity; and
a plurality of mobile devices, each operated by a user for communicating with the server computer over a wireless communications network, each of the mobile devices including a non-browser based, goal-oriented, self-service application running on a self-service client with a graphical user interface adapted for allowing a user of the mobile device to remotely interact with the self-service application running on the server computer to automatically manage tasks involving the given entity.

2. The system of claim 1 wherein each of the mobile devices further includes one or more local applications, each of said one or more local applications being accessible with the self-service application through the graphical user interface.

3. The system of claim 1 wherein the self-service client presents a menu to the user allowing the user to select one of a plurality of alternate customer interaction channels to interact with the given entity, the alternate customer interaction channels including an interactive voice recognition (IVR) system, a Website, and a call center, and wherein the self-service client connects the user to a selected alternate customer interaction channel.

4. The system of claim 1 wherein the self-service application on the server computer transmits data received from a user operating a self-service client to a call center or IVR system when the user makes a telephone call to the call center or IVR system using the mobile device.

5. The system of claim 1 wherein a call center or IVR system transmits to the self-service application on the server computer information relating to a telephone call made by a user to the call center when the user subsequently uses the self-service client to perform further tasks relating to the telephone call.

6. The system of claim 1 wherein for each mobile device, the self-service client adapts itself to characteristics of the mobile device or characteristics of the wireless communications network.

7. The system of claim 6 wherein the self-service client adapts itself by a configuring a thin client, a thick client, or a hybrid thin-thick client.

8. The system of claim 1 wherein for each mobile device, the self-service client assists users in filling form fields displayed in the graphical user interface based on a customized predictive dictionary and historic data stored on the mobile device.

9. The system of claim 1 wherein for each mobile device, the self-service client includes a mobile update manager that detects software upgrades and automatically updates the self-service client by downloading updated software.

10. The system of claim 1 wherein for each mobile device, the self-service client includes tools for downloading new versions of applications and content while old versions of the applications and content are in use in a session, and gradually deploying the new versions of the applications and content after the session has ended.

11. The system of claim 1 wherein for each mobile device, the self-service client is controllable by a remote agent talking to the user on the mobile device.

12. The system of claim 1 wherein the server computer stores data entered by a user of one of the plurality of mobile devices to avoid the user having to reenter the data if a connection between the mobile device and the server computer fails during a session.

13. The system of claim 1 wherein for each mobile device, the self-service client includes a logging mechanism for recording information about user behavior while the user is interacting with the self-service application on the server computer and periodically sending the information to the server computer.

14. The system of claim 1 wherein for each mobile device, the self-service client predicts content and application logic desired by the user and downloads the content and application logic during use of the self-service client by the user.

15. The system of claim 1 wherein for each mobile device, the self-service client is implemented in a markup language particularly configured for use in mobile self-service applications.

16. The system of claim 1 wherein the mobile device comprises a cell phone.

17. A method for enabling users of mobile devices to remotely perform self-service tasks involving a given entity without using human intermediaries, the method comprising:
running a self-service application at a server computer for the given entity; and
for each of the mobile devices, providing a self-service client and a non-browser based, goal-oriented self-service application, the self-service client and the self-service application providing a graphical user interface adapted for allowing a user of the mobile device to remotely interact over a wireless communications network with the self-service application running on the server computer to automatically manage tasks involving the given entity.

18. The method of claim 17 wherein each of the mobile devices further includes one or more local applications, each of said one or more local applications being accessible with the self-service application through the graphical user interface.

19. The method of claim 17 wherein the self-service client presents a menu to the user allowing the user to select one of a plurality of alternate customer interaction channels to interact with the given entity, the alternate customer interaction channels including an interactive voice recognition (IVR) system, a Website, and a call center, and wherein the self-service client connects the user to a selected alternate customer interaction channel.

20. The method of claim 17 further comprising transmitting data received from a user operating a self-service client to a call center or IVR system when the user makes a telephone call to the call center or IVR system using the mobile device.

21. The method of claim 17 further comprising receiving from a call center or IVR system information relating to a telephone call made by a user to the call center when the user subsequently uses the self-service client to perform further tasks relating to the telephone call.

22. The method of claim 17 wherein for each mobile device, the self-service client adapts itself to characteristics of the mobile device or characteristics of the wireless communications network.

23. The method of claim 22 wherein the self-service client adapts itself by a configuring a thin client, a thick client, or a hybrid thin-thick client.

24. The method of claim 17 wherein for each mobile device, the self-service client assists users in filling form fields displayed in the graphical user interface based on a customized predictive dictionary and historic data stored on the mobile device.

25. The method of claim 17 wherein for each mobile device, the self-service client includes a mobile update manager that detects software upgrades and automatically updates the self-service client by downloading updated software.

26. The method of claim 17 wherein for each mobile device, the self-service client includes tools for downloading new versions of applications and content while old versions of the applications and content are in use in a session, and gradually deploying the new versions of the applications and content after the session has ended.

27. The method of claim 17 wherein for each mobile device, the self-service client is controllable by a remote agent talking to the user on the mobile device.

28. The method of claim 17 further comprising storing data entered by a user of one of the plurality of mobile devices to avoid the user having to reenter the data if a connection between the mobile device and the server computer fails during a session.

29. The method of claim 17 wherein for each mobile device, the self-service client includes a logging mechanism for recording information about user behavior while the user is interacting with the self-service application on the server computer and periodically sending the information to the server computer.

30. The method of claim 17 wherein for each mobile device, the self-service client predicts content and application logic desired by the user and downloads the content and application logic during use of the self-service client by the user.

31. The method of claim 17 wherein for each mobile device, the self-service client is implemented in a markup language particularly configured for use in mobile self-service applications.

32. The method of claim 17 wherein the mobile device comprises a cell phone.

33. A method for enabling a user of a mobile device making a telephone call to a call center or IVR to remotely perform self-service tasks involving a given entity without using human intermediaries, the method comprising:
receiving a telephone call from the mobile device of the user at a call center or IVR;
informing the user of the availability of a self-service application to perform a desired task;
activating a self-service application on the mobile device; and
enabling the user to perform the desired task without using human intermediaries using the self-service application.

34. The method of claim 33 wherein enabling the user comprises running a self-service application at a server computer that remotely interacts over a wireless communications network with the self-service application running on the mobile device to automatically manage tasks.

35. The method of claim 33 wherein the self-service application on the mobile device assists users in filling form fields displayed in the graphical user interface based on a customized predictive dictionary and historic data stored on the mobile device.

36. The method of claim 33 wherein activating the self-service application comprises sending a message to the mobile device to wake-up the self-service application.

37. The method of claim 33 further comprising obtaining information from the user and transferring the information to the mobile self-service application prior to enabling the user to perform the desired task using the self-service application.

38. The method of claim 33 further comprising continuing to interact with the user through a voice channel at the same time the user operates the self-service application to assist the user through navigation of the self-service application in a multi-modal interaction interface.

39. A method for enabling a user of a mobile device to remotely perform self-service tasks involving a given entity without using human intermediaries, the mobile device allowing the user to access local content and applications and mobile self-service applications stored on the mobile device from a single integrated interface on the mobile device, the method comprising:
(a) sending a notification to the mobile device of the availability a product or service from said given entity accessible by the user from the mobile device;
(b) activating a self-service application on the mobile device to access said product or service; and
(c) enabling the user to perform a desired task relating to said product or service without using human intermediaries using the self-service application.

40. The method of claim 39 wherein steps (a), (b), and (c) are performed by a server computer that remotely interacts over a wireless communications network with the self-service application running on the mobile device.

41. The method of claim 39 wherein sending said notification comprises automatically sending said notification upon the occurrence of an event.

42. The method of claim 39 wherein activating said self-service application comprises activating said self-service application automatically when the user visits a given Internet site.
